(19) United States
(12) Patent Application Publication
(10) Pub. No.: US 2014/0000969 A1
(43) Pub. Date: Jan. 2, 2014

(54) VEHICLE LOAD SENSING SYSTEM

(71) Applicants: David Carruthers, Livingston (GB); Ernie Di Rollo, Livingston (GB)

(72) Inventors: David Carruthers, Livingston (GB); Ernie Di Rollo, Livingston (GB)

(21) Appl. No.: 13/444,970

(22) Filed: Apr. 12, 2012

Related U.S. Application Data
(63) Continuation of application No. 13/322,740, now abandoned.

(30) Foreign Application Priority Data
May 29, 2009 (GB) 0909261.0
May 29, 2009 (GB) 0909262.8

(51) Int. Cl. G01G 19/12; G01G 19/52; G06F 11/30

(52) U.S. Cl. CPC G01G 19/12; G06F 11/30; G01G 19/52
USPC 177/136; 701/34.4; 177/132

(57) ABSTRACT

A vehicle load sensing system, said system comprising: at least one load sensor located on a vehicle; display means located on the vehicle; wherein the at least one load sensor is capable of measuring and/or monitoring the load being carried in the vehicle and displaying the measured/monitored level on the display means. The display means may further be a standard mobile phone that has a suitable wireless connection. The information transmitted to the display means may also be transmitted to a further information point allowing a central control of a number of vehicles.

### FIELD OF THE INVENTION

The present invention relates to a vehicle load sensing system More particularly, the present invention relates to a vehicle load sensing system capable of measuring and/or monitoring the weight of a load being carried in a vehicle

### BACKGROUND OF THE INVENTION

In order to comply with regulations relating to the loading of commercial motor vehicles and in order to avoid over loading or unsafe distribution of loads, it is necessary to frequently measure the loading of such vehicles The present method of measuring loaded vehicles involves driving the vehicle onto a weighing device such as a permanent or portable scale (eg a weigh bridge) The scale gives the amount of load on each wheel or on each axle, depending upon how it is constructed

This is clearly inconvenient as a weigh bridge is not always available meaning that vehicles can end up driving with excess and unsafe loads which can lead to accidents There is therefore a need to overcome this safety hazard It is an object of at least one aspect of the present invention to obviate or mitigate at least one or more of the aforementioned problems

It is a further object of at least one aspect of the present invention to provide an improved system for measuring and/or monitoring a load being carried by a vehicle It is a further object of at least one aspect of the present invention to provide a permanently installed vehicle load sensing system for measuring and/or monitoring a load being carried by a vehicle.

### SUMMARY OF THE INVENTION

According to a first aspect of the present invention there is provided a vehicle load sensing system, said system comprising: at least one load sensor located on a vehicle; display means located in the vehicle; wherein the at least one load sensor is capable of measuring and/or monitoring the load being carried in the vehicle and displaying the measured/monitored level on the display means.

The present invention therefore uses load sensors mounted on a vehicle which allow a measurement to be made of the weight being carried by the vehicle. This measurement may be done when the vehicle is being loaded so that a maximum safe weight is not exceeded and so that the maximum weight may be carried and transported safely. Continuous measurements may also be made as the vehicle is moving to detect any movement in the load which may lead to a safety hazard. There may be at least one or more load sensors such as two or more or a plurality of load sensors. The load sensors may be as known to the person skilled in the art and may be as defined in U.S. Pat. No. 6,272,936 which is incorporated herein by reference. The load sensors may weigh from anything over 1 kilogram up to several tones of weight.

The load sensors may be located at any position in the vehicle such as on the chassis, the floor plan and/or on the axles of the vehicle. Alternatively, a mat may be used to be placed over the chassis or floor plan of the vehicle with load sensors then being mounted on the mat. On measurement of the weight of the load being carried by the vehicle, the load sensors may then transmit this information to a central processing unit which then processes the received information. The processor unit may then transmit the information to a display means mounted in, for example, the cab or driving area of the vehicle. The display unit may therefore display the weight of the load being carried by a vehicle in, for example, a graphical display using coloured bars or alternatively using a numerical readout.

The processor may be connected to the display unit using a hard wired electrical connection means or alternatively may use a wireless connection. In the event that the load sensors indicate that excessive weight or above a pre-set value is being carried by the vehicle, then a warning signal may be sent to a driver of the vehicle. The warning signal may be either in a visual form and/or an audible warning.

In alternative embodiments, the display unit may be a standard mobile phone that has a suitable wireless connection.

The information transmitted to the display unit may also then be forwarded to a further information point such as in any other country allowing central control of a number of vehicles. This information may be transmitted using, for example, a Global Positioning System (GPS) connection.

The load sensors may also be used to monitor changes (e.g. position) of the load in the vehicle during transit. The variation in the measurement from the load sensor may therefore indicate that the load has become unstable during transit In the event that instability is detected, then a warning signal may be sent to the driver of the vehicle using the display unit using, for example, an audible and/or visual warning.

According to a second aspect of the present invention there is provided a method of measuring the weight of a load in a vehicle using a vehicle load sensing system, said method comprising: providing at least one load sensor located on a vehicle; providing display means located in the vehicle; wherein the at least one load sensor is capable of measuring and/or monitoring the load being carried in the vehicle and displaying the measured/monitored level on the display means. The vehicle load sensing system may be as defined in the first aspect.

According to a third aspect of the present invention there is provided a vehicle comprising a vehicle load sensing system as defined in the first aspect.

The vehicle may be a commercial vehicle (e.g. a van, lorry, truck etc) used for transporting goods. According to a fourth aspect of the present invention there is provided a flexible mat comprising: at least one or more load sensors; wherein the load sensors are capable of measuring the weight of a vehicle and/or load.

Typically, the flexible mat may comprise a series of load sensors which are capable of weighing the weight of a vehicle and/or load driven onto the mat

The flexible mat may also comprise a display unit which may be attached to a printer. The display unit may be hard wired to the flexible mat or may have a wireless connection.

Typically, the flexible mat may be portable and may be used by the police for spot checks to see if vehicles are overweight and carrying dangerous loads.

According to a fifth aspect of the present invention there is provided a case comprising: at least one or more load sensors; wherein the load sensors are capable of measuring the weight of a case and/or load being transported.

The case may therefore comprise a sensor or a plurality of sensors located at a corner which forms the closest point to the ground when being pulled along.

The case of the present invention may therefore be useful for a user in determining the weight of their luggage and ensuring that the weight of the luggage does not exceed weight limits to fly with different airlines. In particular embodiments the case may be a suitcase or any other type of bag used to transport luggage.

### BRIEF DESCRIPTION OF THE DRAWINGS

Embodiments of the present invention will not be described, by way of example only, with reference to the accompanying drawings in which:

FIG. 1 is a representation of a vehicle comprising a load sensing system according to an embodiment of the present invention,

FIG. 2 is a top view of the vehicle shown in FIG. 1,

FIG. 3 is a front view of the vehicle shown in FIGS. 1 and 2,

FIG. 4 is a rear view of the vehicle shown in FIGS. 1 to 3,

FIG. 5 is a schematic representation of a load sensing system according to an embodiment of the present invention comprising a hard wired cable arrangement,

FIG. 6 is a schematic representation of a load sensing system according to a further embodiment of the present invention comprising a wireless connection,

FIG. 7 is a representation of a portable information pod according to a further embodiment of the present invention,

FIG. 8 is a representation of a portable information pod according to a yet further embodiment of the present invention,

FIG. 9 is a representation of a dashboard in a vehicle according to an embodiment of the present invention,

FIG. 10 is a representation of a weigh mat according to a yet further embodiment of the present invention, and FIG. 11 is a representation of a suitcase according to a further embodiment of the present invention

### BRIEF DESCRIPTION

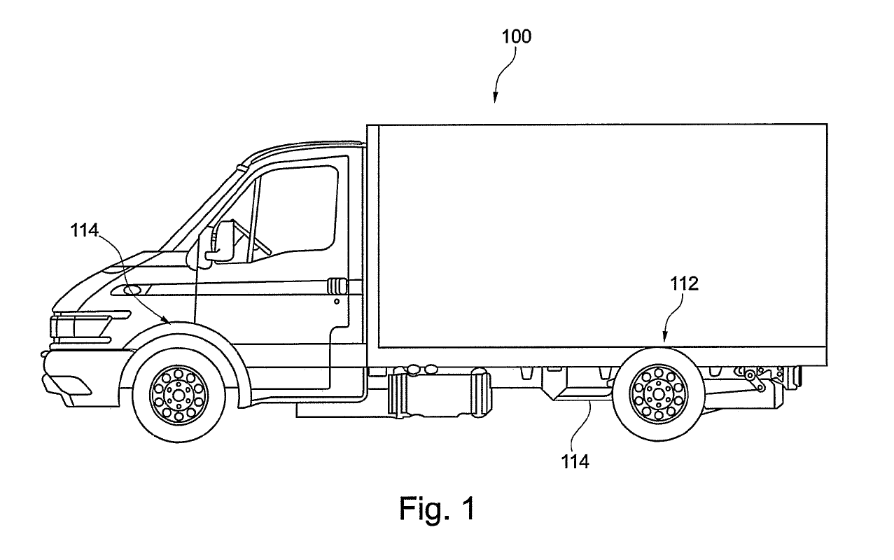

The present invention therefore relates to a vehicle load sensing system capable of measuring and/or monitoring the weight of a load being carried in a vehicle and displaying the measured load on a display panel. FIG. 1 is a representation of a vehicle generally designated 100 according to the present invention. As shown in FIG. 1 the vehicle 100 has sensors located at positions 112, 114 and standard leaf springs 116.

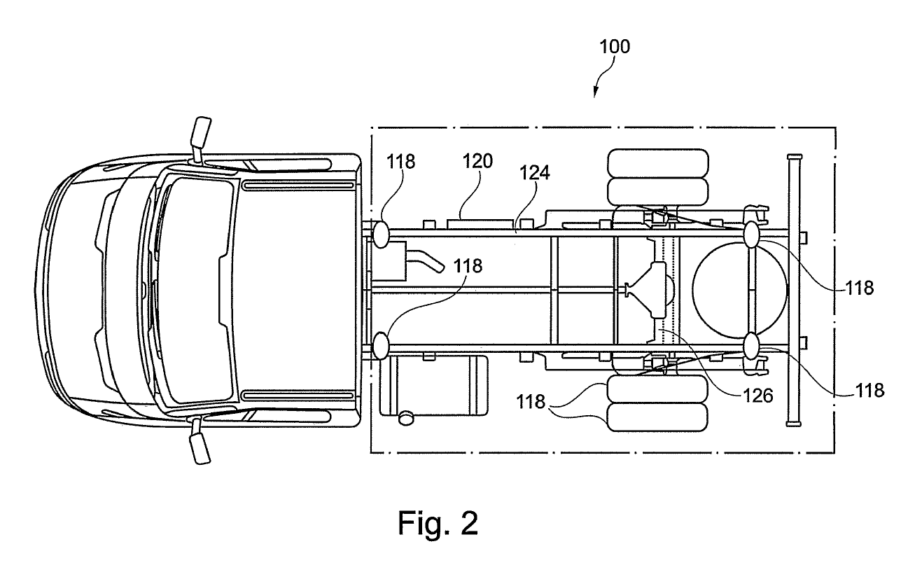

FIG. 2 which is a top view of the vehicle 100 shows the location of the sensors 118 which can be located on the chassis 124 of the vehicle 100 or one of the axles 126. FIG. 2 also shows that the vehicle 100 comprises a processor 120 which is used to process the information from the sensors 118.

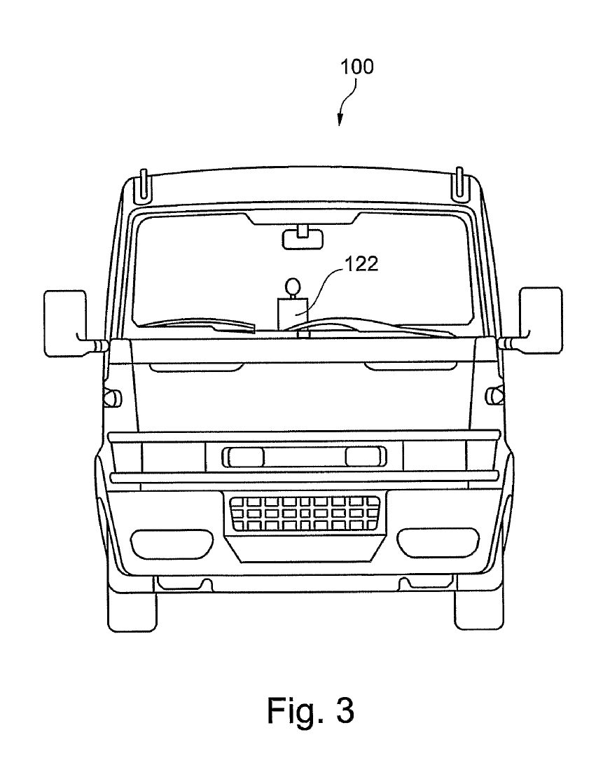

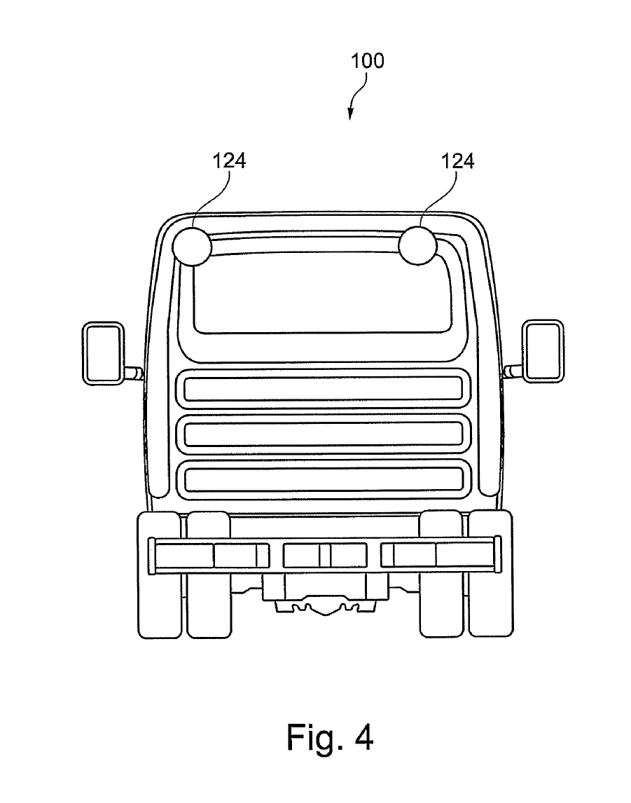

FIG. 3 is a front view of the vehicle 100 which shows that the vehicle 100 comprises a display 122. The display 122 is used to display the measurements taken from the sensors 118 FIG. 4 is a rear view of the vehicle 100 showing audible warning sounders 124.

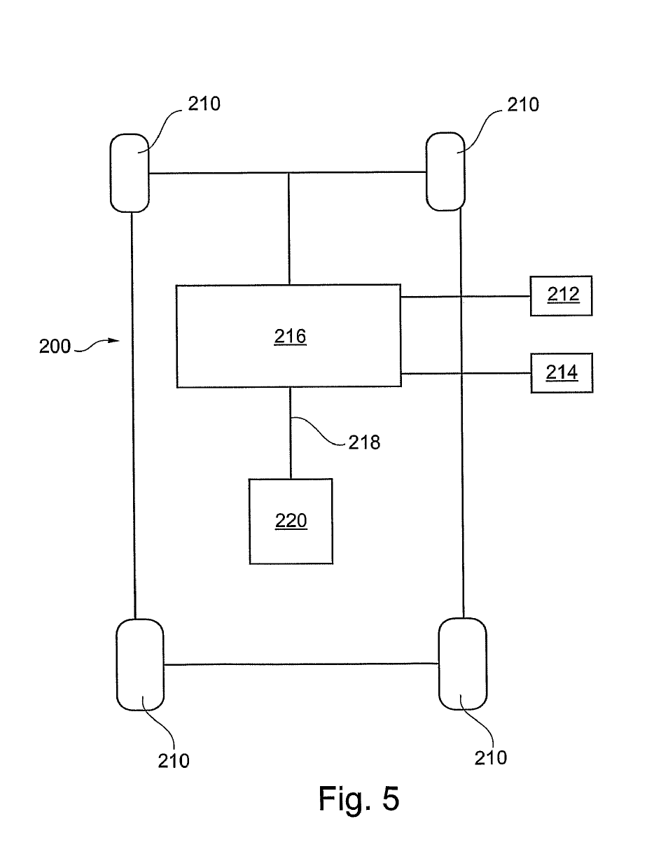

FIG. 5 is a representation of a load sensing system according to the present invention generally designated 200. As shown in FIG. 5 the load sensing system 200 comprises load sensors 210 (e.g. tactile load sensors) which are centrally connected to a processor 216. The processor 216 is also connected to an audible warning device 212 and a visual warning device 214 in the event that the vehicle is overloaded. The processor 216 is connected to a display 220 via a hard wire cable 218. The processor 216 therefore processes the measurements taken from the load sensors 210 and displays these on the display 220 to a person inside the vehicle.

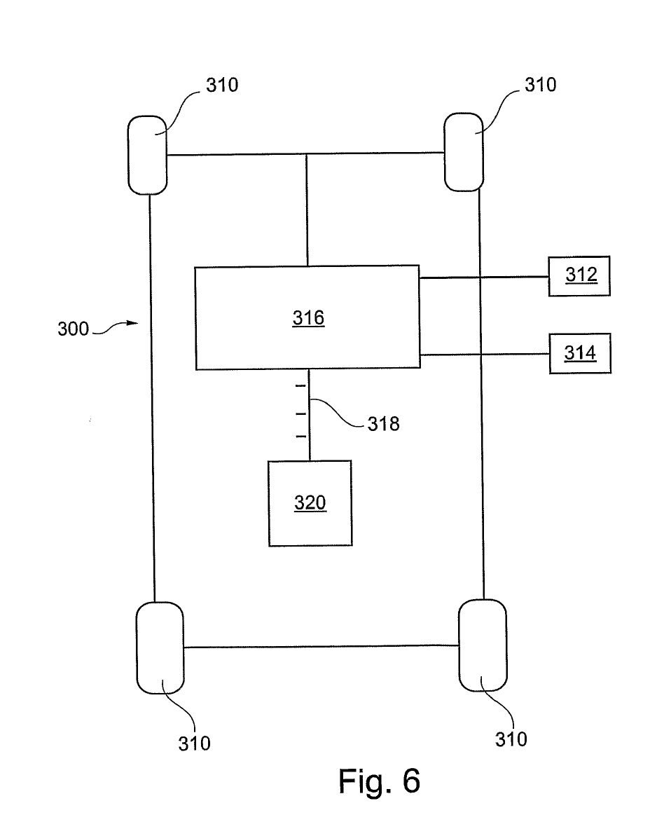

FIG. 6 is a view of a further load sensing system 300 according to the present invention The load sensing system 300 comprises load sensors 310, and a processor 316 which is connected to an audible warning device 312 and a visual warning device 314 The load sensing system 300 also comprises a display 320 The load sensing system 300 is therefore similar to the load sensing system 200 shown in FIG. 5 apart from the fact that the display 320 is controlled via a wireless connection 318

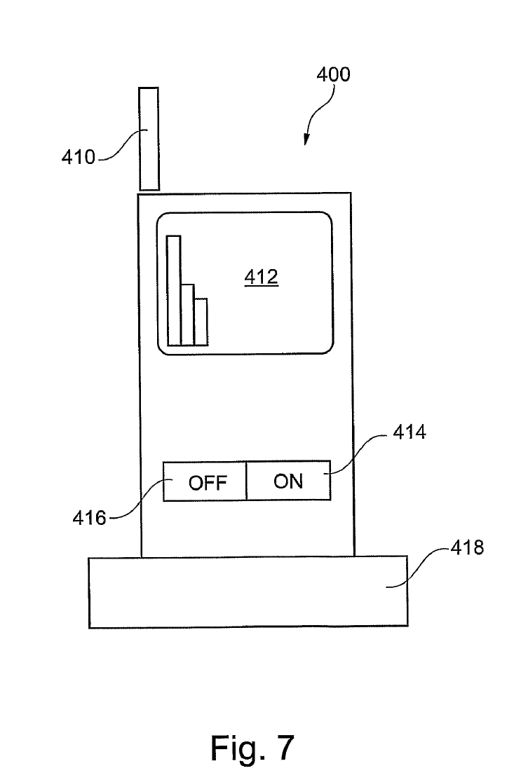

FIG. 7 is a view of a portable information pod 400 according to the present invention The portable information pod 400 comprises a wireless antenna 410, a screen 412 an on button 414 and an off button 416 As shown in FIG. 7 the portable information pod 400 is held in a docking station 418

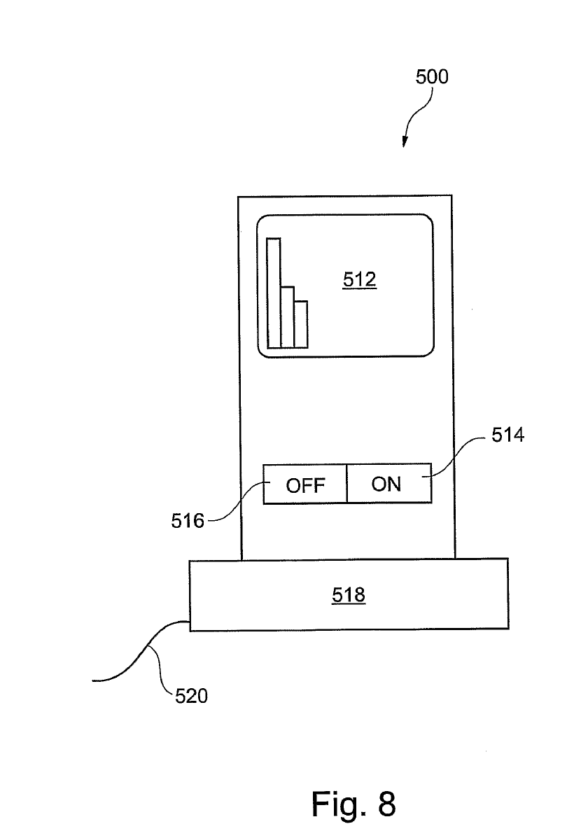

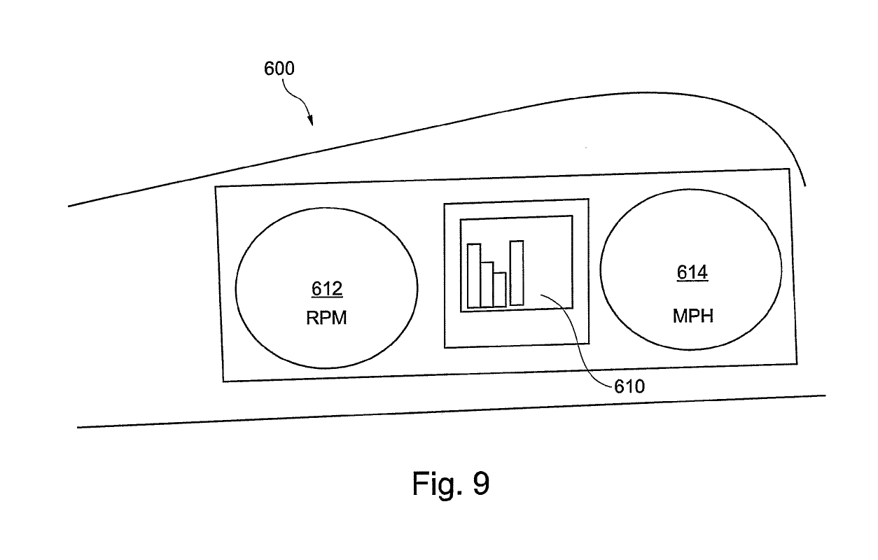

FIG. 8 is a view of another portable information pod 500 The portable information pod has a display screen 512, an on button 514, an off button 516 and is held in a docking station 518 As shown in FIG. 8, the portable information pod 500 is hard wired via a cable 520 to a processor

FIG. 9 is a view of a dash board 600 which is located inside a vehicle The dashboard 600 comprises a revs per minute counter 612, a miles per hour counter 614 and a centrally mounted dashboard information display 610 which may be used to display the measurements taken from the load sensors The present invention therefore enables the load (t e weight) being carried by a vehicle such as a commercial vehicle (e g a van, lorry, truck etc) to be indicated and displayed inside the cab or driving area of the vehicle Continuous measurements may occur as the vehicle is being loaded so that the maximum weight of material may be transported by the vehicle but still at a safe level The load sensors may also measure the distribution of the weight over the carrying load area of the vehicle thereby ensuring that the load is evenly distributed and ready for transport This may help in the transport of heavy loads

The vehicle comprises a number of sensors (e g tactile force sensors) which can be placed either directly to the chassis of the vehicle, at least one or a plurality of axles and/or onto a rigid and/or flexible mat which is placed on the base/chassis of the vehicle Any suitable number of sensors may be used with the number of sensors being required dependent on the size of the vehicle, the load being measured in the vehicle and the size of the load area to be measured The sensors can either be connected in series or parallel Once the sensors have measured the weight of the load being earned by the vehicle, this measurement is then relayed to a processor unit using, for example, a wireless or connected cable The processor in the load vehicle system therefore processes the gathered information, processes it and sends this information to a display unit which is mounted, for example, in the cab The display unit mounted in the cab allows the load being earned to be displayed visually and/or audibly For example, a display screen with a number of bars and/or a numerical read-out may be used to show the weight being carried by the vehicle The display unit can also be a mobile phone with a wireless or Bluetooth (Trade Mark) connection There is also the option for the information received by the display unit to then be forwarded to any point in any country by means of a Global Positioning System (GPS) connection

The system can also display any load movement within the load area as the sensors will deduct any shift in load as the processors constantly monitor the load The sensors work in principle by measuring the weight placed on top of them which is reflected against a measuring plate. The signal from the sensors is sent to a processing unit which then processes the signal and then transfers this information to a display unit. The display unit can display the information in any suitable means such as in either a load indication from using a system of lights and/or is displayed in a format that enables a weight to be displayed in, for example, pounds and ounces or kilograms and grams.

In the event that the load measured exceeds a pre-set value for the maximum carrying load for the vehicle, then a warning signal may be sent to the driver. This warning signal may come in either the form of an audible warning or may be displayed on the display unit.

The load sensors are also capable of measuring variations in the load during driving in the event that significant variations are detected. In the event that a shifting load is detected then a warning via an audible or visual signal may be sent to a driver by the display unit indicating that the load is in danger of unstabiling the vehicle.

The display mounted in the cab can either be a purpose made display unit or the display can be made using a standard mobile phone that has a suitable wireless connection. The phone will display the signal from the processor unit after a software update has been installed in the mobile phone. As a signal is sent to the display there is an option for the signal to be dispatched via GPS to a suitable receiving unit.

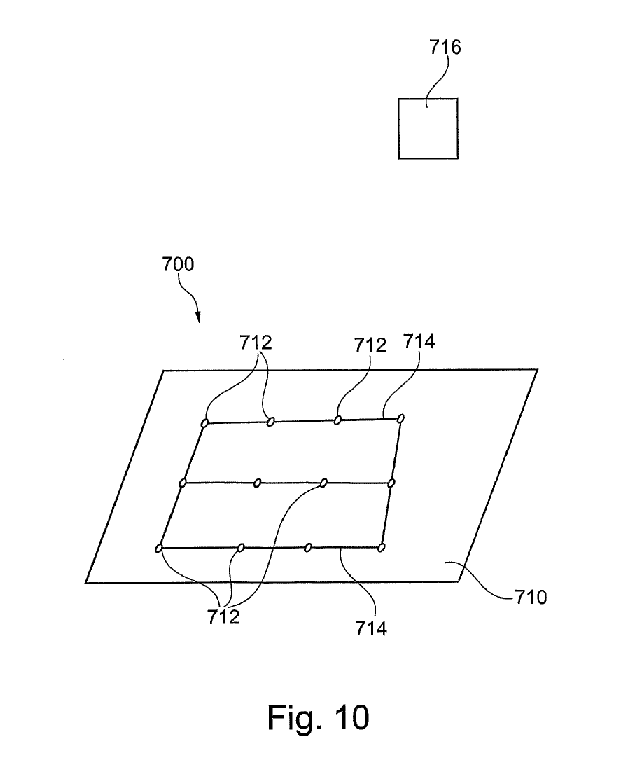

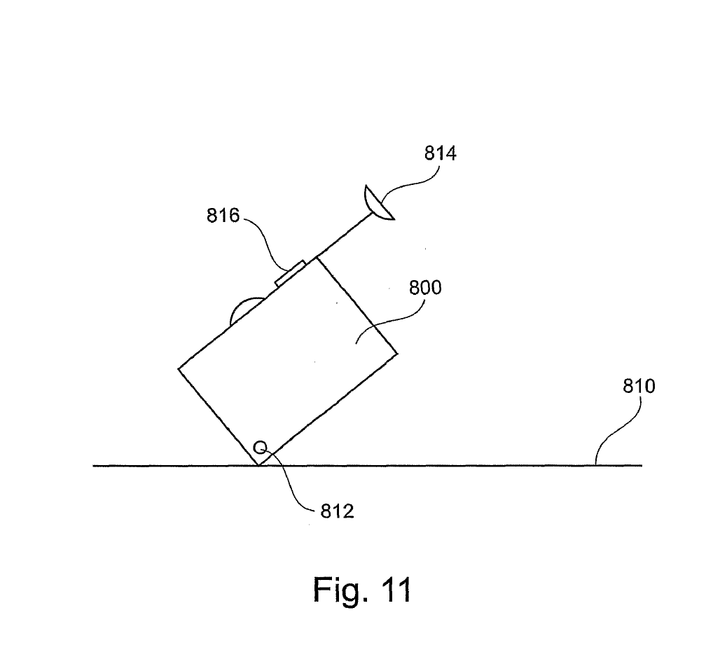

FIG. 10 is a representation of a weigh mat according to the present invention generally designated 700. The weigh mat 700 is flexible and comprises a series of load sensors 712 which are capable of weighing the weight of a vehicle and/or load driven onto the mat 700. The sensors 712 may be mounted between two layers of flexible material. As shown in FIG. 10 there is a display unit 716 which is used to display the weight of the vehicle and/or load. The display unit 716 may be attached to a printer (not shown). The display unit 716 may be hard wired to the weigh mat 700 or may have a wireless connection. Such a weigh mat 700 may be used to replace an expensive weigh bridge. The weigh mat 700 also has the advantage in that the weigh mat 700 is portable and may be used by the police for spot checks to see if vehicles are overweight and carrying dangerous loads. FIG. 11 is a representation of a suitcase according to the present invention, generally designated 800. The suitcase 800 as shown in FIG. 11 is being pulled along the ground 810. The suitcase 800 comprises a sensor 812 located at a corner which forms the closest point to the ground when being pulled along. The suitcase comprises a handle 814 to be used by a user. The suitcase 800 also comprises a display unit 816 which displays the amount of the weight of the filled suitcase 800. The suitcase 800 of the present invention is therefore useful for a user in determining the weight of their luggage and ensuring that the weight of the luggage does not exceed weight limits to fly with different airlines.

Whilst specific embodiments of the present invention have been described above, it will be appreciated that departures from the described embodiments may still fall within the scope of the present invention. For example, any suitable type of load sensor may be used to measure the weight of the load being carried by a vehicle. Moreover, any suitable type of display means may be used to display the information.

1. A vehicle load sensing system, said system comprising:
at least one load sensor located on a vehicle;
display means located 5 in the vehicle;
wherein at least one load sensor is capable of measuring and/or monitoring the load being carried in vehicle and displaying the measured/monitored level on the display means.

2. A vehicle load sensing system according to claim 1, wherein at least one load sensor is located on a chassis, floor plan, axle and/or a mat on the vehicle and is capable of allowing a measurement to be made of the weight being carried by the vehicle.

3. A vehicle load sensing system according to claim 1, wherein the at least on load sensor is capable of preventing the vehicle from being overloaded.

4. A vehicle load sensing system according to claim 1, wherein the at least one sensor is capable of continually measuring the load as that any movement in the load which may lead to a safety hazard is capable of being detected.

5. A vehicle load sensing system according to claim 1, wherein there is at least one or more, two or more or a plurality of load sensors.

6. A vehicle load sensing system according to claim 1, wherein on measurement of the weight of the load being carried by the vehicle, the load sensors then transmit this information to a central processing unit which then processes the received information, and the processed information is transmitted to a display means mounted in, for example, the cab or driving area of the vehicle.

7. (canceled)

8. A vehicle load sensing system according to claim 1, wherein the display unit displays the weight of the load being carried by the vehicle in a graphical display using colored bar or in a numerical readout.

9. A vehicle load sensing system according to claim 1, wherein a processor is connected to the display unit using a hard wired electrical connection means or a wireless connection.

10. A vehicle load sensing system according to claim 1, wherein in the event that the load sensors indicate that excessive weight or above a pre-set value is being carried by the vehicle, then a warning signal is sent to a driver of the vehicle.

11. A vehicle load sensing system according to claim 1, wherein the warning is in the form of a visual form and/or an audible warning.

12. A vehicle load sensing system according to claim 1, wherein the display unit is a standard mobile phone that has a suitable wireless connection.

13. A vehicle load sensing system according to claim 1, wherein information transmitted to the display unit is also transmitted to a further information point allowing central control of a number of vehicles.

14-16. (canceled)

17. A flexible mat comprising:
at least one or more load sensors;
wherein the load sensors are capable of measuring the weight of a vehicle and/or load.

18. A flexible mat according to claim 17, wherein the mat comprises a series of load sensors which are capable of weighing the weight of a vehicle and/or load driven onto the mat.

19. A flexible mat according to claim 17, wherein the flexible mat comprises a display unit which is attachable to a printer.

20. A flexible mat according to claim 19, wherein the display unit is hard wired to the flexible mat or has a wireless connection.

21. A flexible mat according to claim 17, wherein the flexible mat is portable and is used by the police for spot checks to see if vehicles are overweight and carrying dangerous loads.

22. A case comprising:
at least one or more load sensors;
wherein the load sensors are capable of measuring the weight of a case and/or load being transported.

23. A case according to claim 22, wherein the case comprises a sensor or a plurality of sensors located at a corner which forms the closest point to the ground when being pulled along, the case is capable of determining the weight of their luggage and ensuring that the weight of the luggage does not exceed weight limits to fly with different airlines, and wherein the case is a suitcase or any other type of bag used to transport luggage.

24-25. (canceled)
